(19) United States
(12) Patent Application Publication
(10) Pub. No.: US 2008/0071129 A1
(43) Pub. Date: Mar. 20, 2008

(54) Nanopore Reactive Adsorbents for the High-Efficiency Removal of Waste Species

(76) Inventors: Arthur J. Yang, York, PA (US); Roman Domszy, Lancaster, PA (US)

Correspondence Address: JONES DAY, 222 EAST 41ST ST, NEW YORK, NY, 10017, US

(21) Appl. No.: 10/571,756

(22) PCT Filed: Sep. 10, 2004
(86) PCT No.: PCT/US04/29450

§ 371 Date: Oct. 3, 2007

Related U.S. Application Data
(60) Provisional application No. 60/502,224, filed on Sep. 12, 2003.

(51) Int. Cl. A62D 3/00; B01D 15/00

(52) U.S. Cl. 588/301; 428/219; 428/220; 428/306.6; 428/308.4; 428/315.5; 435/174; 502/150; 588/315

(57) ABSTRACT

A nanopore reactive adsorbent composite material, which may be a porous adsorbent, has a composition and microstructure, which integrates adsorbency, reactivity and catalysis. Integration may be achieved by modifying nanopore surfaces with dense ligand groups and by embedding at least one reactant phase effective to accomplish a sequence of reactions of which at least one reaction may be catalyzed by the surface ligand groups. The solid reactant phase may include reactive metal particles, such as, Mg, Sn, Al, Fe, or Zn, or mixtures thereof, and may be effective as in-situ reducing agent. A macroporous adsorbent, may be formed from the composite material. Recovery of mercury from a contaminated liquid is described. A second reactive phase, which may comprise a sulfur polymer or another metal effective to immobilize liquid mercury in-situ, may be included in or with the composite.

### CROSS REFERENCE TO RELATED APPLICATION

This application claims priority from U.S. application Ser. No. 60/502,224, filed Sep. 12, 2003.

Mercury is a highly toxic liquid metal which occurs naturally in the environment and is also generated through human activities such as the production of electricity from coal-fired power plants, waste incineration and fuel combustion. Environmental initiatives and policy changes have already helped decrease the amount of mercury discharged into the environment. However, mercury pollution remains a serious problem. Technology breakthroughs in mercury remediation would most likely be implemented more effectively and efficiently than any effort to establish an international protocol regulating mercury discharge.

One emerging scientific field which demonstrates great promise in being able to resolve the shortcomings of existing mercury treatment is nanotechnology, which is defined by the National Nanotechnology Initiative (NNI) as research and technology development in the length scale of approximately 1-100 nanometer range to create and use structures, devices and systems that have novel properties and functions because of their small and/or intermediate size. The novel and differentiating properties and functions are typically developed at a critical length scale of matter under 100 nm. Virtually all treatment technologies for mercury currently have shortcomings that could be substantially improved by some type of nanotechnology.

### BRIEF DESCRIPTION OF THE DRAWINGS

FIG. 1 is a backscattered Scanning Electron Microscope (SEM) (JOEL JSM-5900LV) photoimage (ultimate resolution 3 nm) of a fresh chemically surface-modified gel (CSMG)-Iron composite according to an embodiment of the present invention;

FIG. 2 is a backscattered SEM of the CSMG-Iron composite shown in FIG. 1, after exposure to a silver nitrate solution;

FIG. 3 is a schematic diagram of a structure of a composite material according to an embodiment of the invention; and

FIG. 4 is a graphic representation of the results, in terms of silver metal concentration, versus number of bed 444444 volumes, following the treatment of a standard solution with 1000 ppm initial silver concentration using a CSMG/clay/iron composite according to an embodiment of the present invention.

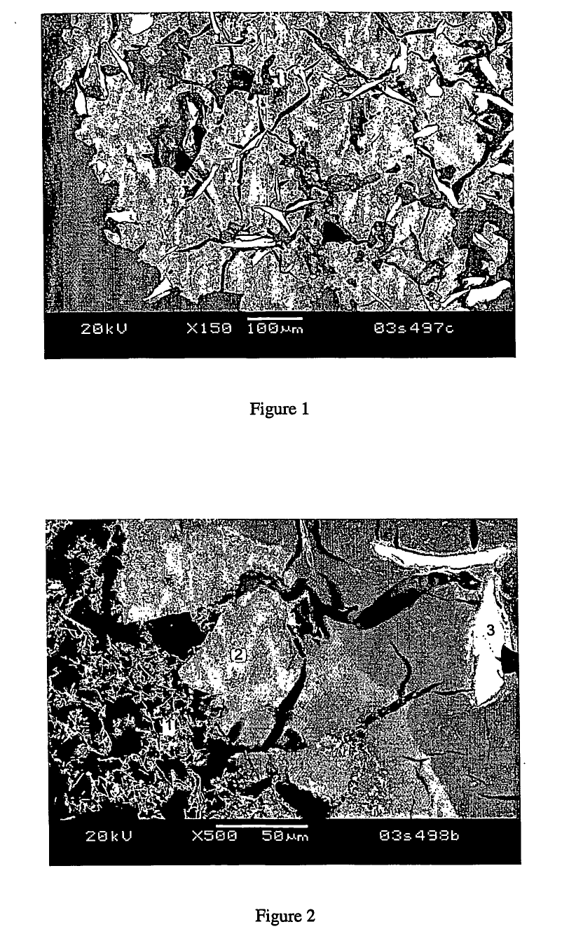

In one embodiment, this invention provides a new nanoscale reactive adsorption technology that can simultaneously improve the efficiency and capacity of mercury treatment and precious metal recovery. The treatment efficiency may be measured by the residual concentration of a waste after treatment while the capacity is normally measured by the total volume that can be treated by a fixed volume (i.e. numbers of the bed volume).

Embodiments of the present invention integrate unique features of several working modes (e.g., adsorption, reductive reaction, partition-extraction, solidification) into one operation by applying highly advanced material nanotechnology, whereby the efficiency, capacity, processing speed and cost of mercury treatment for both groundwater remediation and waste management may be significantly improved. Other embodiments of the invention adopt this technology for recovering other precious metals, such as, silver, gold, palladium, and the like.

Because of the extremely low solubility of HgS (solubility product Kₛₚ˜3×10⁻⁵³) in water, precipitation by sulfide is considered to be the most exhaustive means of mercury removal. Even for mercury removed by other methods, the eventual goal of a complete immobilization is to convert mercury to a sulfide compound. However, treating ground water or a low concentration waste by sulfide precipitation has many practical difficulties. Besides the possibility of releasing toxic H₂S fumes during processing, the precipitation and subsequent filtration of a colloidal HgS is slow and tedious. Polymer coagulants are often needed to facilitate the removal of precipitates. However, the material cost, processing speed, and sludge handling present obstacles for a large-scale operation such as those treating groundwater or industrial waste.

A significant technology breakthrough in this field is the immobilization of molecular recognition ligand groups onto the surface of a nanopore substrate see, e.g., X. Feng, G E. Fryxell. L-O. Wang, A. Y. Kim, J. Liu, and K. M. Kemner, Science, 276, pp 865 (1997). Porous materials, composed of nanoparticles, have a substantially larger surface area than conventional adsorbents. In embodiments of this invention —SH ligand groups are incorporated onto the pore surface, whereby the adsorption of mercury becomes selective, as exhaustive as precipitation by sulfide, and substantial (a combination of selectivity and large surface area). Thus, embodiments of this invention provide nanoparticle reactive adsorbents which integrate precipitation, coagulation, and chemical adsorption into one operation, and may achieve significant improvements in treatment efficiency and capacity resulting from the application of nanotechnology with reactive ligands.

The present inventor(s) and/or co-workers for the assignee have been involved in applying nanotechnology for recovering silver from photographic waste. These efforts resulted in a chemically surface modified gel (CSMG) having high surface area with extremely high loading of functional groups that increases adsorption efficiency and capacity. The CSMG may be obtained by reacting a freshly prepared silica gel, which contains many silanol groups (Si—OH) on a large surface area (500˜1000 m²/g), with a silane coupling reagent ( e.g., 3-mercaptopropyl- trimethoxysilane, Si(OCH₃)₃—(CH₂) ₃—SH ) and have applied these nanoadsorbent based CSMG materials to achieve selective adsorption of silver from photographic waste. A description of the preparation of CSMG is found in the commonly assigned U.S. application Ser. No. 601,888, filed Aug. 9, 2000, the disclosure of which is incorporated herein, in its entirety, by reference thereto. In a subsequent development by at least one of the present inventors a reactive species is embedded into the structure of a nanopore adsorbent to facilitate the treatment capacity of the adsorbent towards a specific waste or environmentally damaging or suspect specie and/or recoverable specie having intrinsic value. This technology is the subject of copending U.S. application, Ser. No. 10/110,270, filed Apr. 9, 2002, as the National Phase of International Application PCT/US00/24472, filed Sep. 7, 2000, and published on Mar. 15, 2001, under number WO 01/17648, the disclosures of which are incorporated herein by reference thereto.

Although the general principles of incorporating metal-ion binding functional groups onto the surface of nanopore silica are generally known, the characteristics of the resulting silica-ligand composite products may differ significantly depending on the routes of processing. See, e.g., L. Mercier and T. Pinnavaia, Adv., Mater., 9, No. 6, pp 500-503 (1997); L. Mercier, C. Detellier, Environ. Sci. Technol, 29. p 1316 (1995); M. S. Iamamoto, Y. Gushikem, J. Colloid Interface Sci. 129, p 162 (1989); E. I. S. Andreotti, Y. Gushikem, J. Colloid Interface Sci. 142, p 97 (1991); W. C. Moreira, Y. Gushikem, 0. R. Nascimento, J. Colloid Interface Sci. 150, p 115 (1992); W. C. Moreira, Y. Gushikem, O. R. Nascimento, J. Colloid Interface Sci. 150, p 115 (1992); U.S. Pat. No. 5,814,226, U.S. Pat. No. 5,817,239. Compared with traditional treatment methods, the reactive CSMG product, as described in the aforementioned applications, has the following features:
The surface area (˜900 m²/g silica) is 10-100 times larger than common adsorbents with micron size particles.
It has the highest loading of surface ligand groups (˜7.5 mmole per gram of silica, 100% coverage) which, coupled with the large surface area, results in exceptionally high adsorption efficiency.
The thiol (—SH) groups, chemically immobilized to silica, can achieve a complete, selective precipitation of heavy metal ions without needing toxic H₂S and additional coagulants.
It may be regenerated many times by strong acid backwash for reuse, while substantially concentrating a waste batch for transportation or further treatment.

Reactive CSMG utilizes the unique material properties of a nanopore substrate to synergistically integrate the two traditional modes of treatment—adsorption and reaction—into one process that has substantially improved capacity and efficiency. Reactant particles (e.g. iron) are embedded within a nanopore structure to react with metal, e.g., silver, ions adsorbed by CSMG. The ligand adsorption, by increasing the surface concentration and residence time of the metal ions, e.g., silver, mercury, etc., promote reactions with the embedded reactant, e.g., iron, aluminum, etc., particles. Meanwhile, the continuous in-situ reduction of the reducible metal, e.g., silver, ions into metallic metal, e.g., silver, refreshes the surface ligands for additional adsorption of metallic, e.g., silver, ions.

In embodiments of this invention, the reactive adsorption technology is specifically modified for the purpose of mercury recovery to enhance the treatment efficiency, capacity and speed to a level where the waste species, e.g., mercury, removal from groundwater or from low concentration batches would be economically feasible. In an embodiment of the invention, surface reactive groups, such as surface thiol groups, may catalyze other in-situ mercury reactions as well by interacting strongly with all forms of mercury. In embodiments of the present invention involving the simultaneous adsorption, reaction, and catalysis of reactive CSMG, an in-situ immobilization reaction between mercury and a sulfur polymer is provided. Reactions between mercury and sulfur polymers have been successfully applied to the immobilization of elemental mercury wastes meeting EPA leaching criteria, and are also known to have low mercury vapor pressure. See, e.g., “Sulfur Polymer Solidification/Stabilization of elemental mercury waste”, M. Fuhrmann, et al., Waste Management 22 (2002) 327-333; U.S. Pat. No. 6,399,849—the disclosures of which are incorporated herein by reference thereto.

In one embodiment of the invention the nanopore reactive adsorbent composite may be fabricated to facilitate handling and use, for example, the composite nanoparticle adsorbent may be fabricated into a “macro” sized unit, e.g, rods, pellets, granules, with introduced porosity. The degree of porosity is not particularly critical but should be sufficient to provide sufficient pathways to allow liquid access to the nanoparticle adsorbent. Usually, too, the added porosity should result in a macro unit density at least substantially corresponding to the density of the liquid medium to be treated with the adsorbent composite. For example, when used for treating an aqueous liquid system, a density of approximately 1 g/cc will allow sufficient contact of the liquid media with the nanopore reactive adsorbent composite particles in the macro unit.

While the additional porosity may be introduced by various known means, for example foaming agents, gas-forming agents, etc., generally, any inert porogen, e.g., mineral oil, which may be removed after rod, pellet, granule, etc., formation, such as by extraction, may be used.

Following the strategy of various embodiments of this invention, the integration of treatment, recovery and immobilization into one operation using reactive CSMG may provide substantially reduced processing and engineering costs of mercury remediation.

The production of CSMG composites have been successful using a water based reaction at a moderate temperature. The ligand groups are completely immobilized with the silica substrate, such that only traces of mercaptan and ethanol will be in the waste water discharged during production. When this product is used in field operations according to embodiments of the invention, mercury is captured by adsorption, and reduced by iron, and may then be immobilized by reacting with a sulfur-based polymer or by formation of an amalgam with an appropriate metal. Immobilization via amalgamation or, perhaps, even more so via a sulfur-based polymer should allow the resulting waste to be disposed of safely. The only waste generated during the treatment process would then be the metal, e.g., ferric or ferrous ions, which will be produced in an amount proportional to the reduction of mercury and oxidation by air.

The efficiency of CSMG for treating several types of metal ions may be demonstrated using a batch adsorption experiment at room temperature to determine the partition coefficient of an ion. The adsorbent (10 mg) is stirred with 50 ml of metal ion solution for 30 minutes at initial concentrations ranging from 5 to 10 ppm. Metal ion concentrations, before (Cᵢₙᵢₜᵢₐₗ) and after (C_{eq}) treatment, are determined using atomic adsorption spectroscopy. The results of this procedure are summarized in the Table 1:

TABLE 1

| | | | | Partition coefficient |
|---|---|---|---|---|
| | | | Adsorption | mg per gm |
| | | | (mg/g) | solid/mg per gm |
| | Cᵢₙᵢₜᵢₐₗ (ppm) | C_{eq} (ppm) | at equilibrium | solution |
| Ag⁺ | 7.2 | 0.002 | 36.0 | 17,995,000 |
| Pb²⁺ | 6.5 | 0.028 | 32.4 | 1,155,714 |
| Hg²⁺ | 6.6 | 0.004 | 33.0 | 8,245,000 |
| Cu²⁺ | 6.6 | 0.012 | 33.0 | 2,745,000 |

The adsorption capacity of an adsorbent for metal ions varies significantly with the solution pH. For mercaptan loaded CSMG, adsorption capacity is expected to rise with increasing solution pH. The following tests may be performed to determine the adsorption capacity of CSMG towards respective metal ions at pH value of three. To test the maximum adsorption of CSMG, 140 mg of adsorbent is mixed with a 200 ml solution of each type of metal ion for 1 hour at the initial concentrations indicated in the Table 2. Ion concentrations before (Cᵢₙᵢₜᵢₐₗ) and after (C_{final}) treatment are determined using atomic adsorption spectroscopy.

TABLE 2

| | | | | Capacity (mg/g |
|---|---|---|---|---|
| | | | | adsorbent) |
| | Cᵢₙᵢₜᵢₐₗ (ppm) | C_{final} (ppm) | Adsorbed (mg) | At pH = 3 |
| Ag⁺ | 970 | 475 | 99 | 707 |
| Pb²⁺ | 1130 | 953 | 35.4 | 253 |
| Hg²⁺ | 904 | 388 | 103 | 737 |
| Cu²⁺ | 930 | 760 | 34 | 243 |

The ligand loading (e.g., 7.5 mmole/gram silica), partition coefficient, and capacity of CSMG are believed to be the highest among competing technologies. In embodiments of this invention, the capacity of CSMG, for the specific purpose of mercury treatment, is further improved by creating a reactive version of CSMG that has added functionality in addition to selective adsorption. Specifically, according to this embodiment the treatment capacity and speed of CSMG for mercury is enhanced by integrating two other functions, reaction and catalysis, with the high-efficiency adsorption already achieved by CSMG.

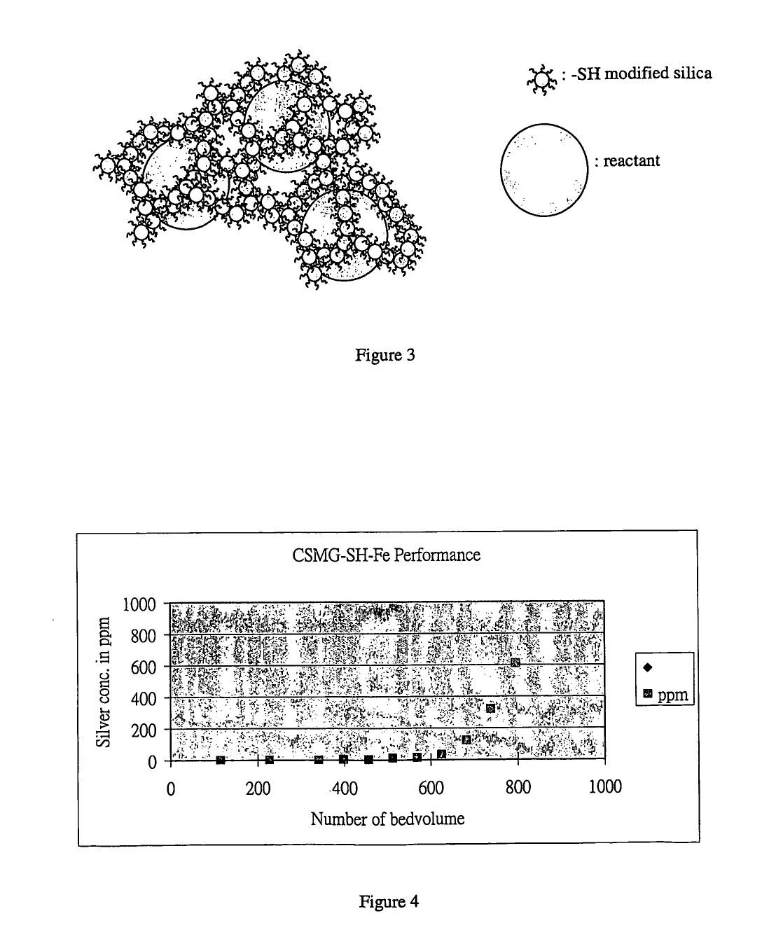

As described previously, the in-situ reaction of silver ions with iron benefited from the strong adsorption of ions by ligand groups due to a prolonged residence time and a higher surface population. Moreover, the surface ligand groups, being so close to a reactant, could additionally function as a catalyst to the intended reaction to further accelerate the treatment speed. In the present invention, adsorbed mercury ions are reduced by the embedded reactant particles into metallic mercury. In one embodiment, the embedded reactant particles are iron particles. The formation of this metallic phase requires a nucleation step which can be catalyzed by the presence of the layer of dense surface thiol groups. The structure of the composite material may be illustrated by the representative diagram shown in FIG. 3. As seen in FIG. 3, the relatively larger reactant particles are embedded or interspersed among and between the nanoporous adsorbent particles.

Combining the three functions (selective adsorption, reaction and catalysis) in the form of a nanopore reactive adsorbent could substantially increase the recovery of the waste or recoverable species, e.g., silver from photographic waste. This same general approach is applied to the treatment of mercury-contaminated water, and increases the efficiency, capacity and speed of mercury treatment to a level that exceeds the performance of existing technologies.

The following procedures are included in embodiments of this invention:
Integration of adsorption, reaction and catalysis for mercury recovery
Composites according to embodiments of the invention, having, for example, a composition of 22 wt % silica, 62 wt % iron, and 16 wt % surface-loaded mercapto-silane, or 30 wt % silica, 40 wt % iron, and 30 wt % surface-loaded mercapto-silane, have been found effective in silver recovery and in mercury recovery. More generally, exemplary compositions of the composite materials according to various embodiments of the invention may include from about 20 to 30 wt % nanoporous silica or other nanoporous sol material, from about 40 to 75 wt % reactant (e.g., iron), and from about 10 to 30 wt % surface loaded ligand groups (e.g., mercapto-silane). In other embodiments, these ratios may include from about 20 to 25 wt % silica, 50 to 65 wt % reactant and 10 to 20 wt % surface-loaded ligand groups. In still other embodiments, the composite according to the invention may include from about 20 to 25 wt % silica, from about 55 to 65 wt % reactant and from about 15 to 20 wt % surface-loaded ligand groups. Mercury's reduction potential and affinity to the thiol (—SH) ligand group are very similar to that of silver. However, the detailed chemistry involved is different since both Hg₂²⁺ and Hg²⁺ ions and complexed species could be present in a waste stream. The efficiency and speed would correlate primarily with the ligand loading density, while the capacity is dictated by the amount and particle morphology of iron. Optimization of the adsorbent by varying reactants and surface ligand groups Embodiments of this invention effect a chemistry change through the use of a different reactant and/or type of surface ligand. For example, metals such as tin, zinc and aluminum may be used as replacements to iron; each has a reduction potential that is either below (Sn) or above (Zn and Al) that of iron, meaning that each would have a different reducing power towards mercury ions. In another embodiment magnesium (Mg) is used to form a mercury amalgam. The solution thermodynamics are considered to be far more complex than what is manifested by oxidation-reduction potentials. For a reaction in a nanopore substrate, the interaction of surface ligands with reactive species is an integral part of the reaction thermodynamics. Consequently, the type and loading density of the surface ligand are critical to reaction optimization. Embodiments of this invention include incorporating surface ligands with amino and chelating diamino functional groups which demonstrated high affinities for heavy metal ions. Furthermore, reaction kinetics such as precipitation of oxides on the metal surface, complex formations, over-voltage, and competing reactions might even be more significant considerations than thermodynamics. Embodiments of this invention optimize the reduction of mercury by fine-tuning the solution chemistry as well as the micro reaction environment created by ligand interactions near reaction sites.
Mercury immobilization by amalgamation or reaction with a sulfur polymer
After being reduced to metallic form, mercury in its liquid form is not reliably retained within a filtration column. Embodiments of this invention include an alloy-forming metal with the reactive CSMG in order to capture and immobilize the liquid mercury. This metal may be embedded within or simply mixed with the composite particles for mercury extraction. In embodiments of the invention, stable mercury amalgam forming metals are used. In one embodiment iron is used as the amalgam forming metal. In other embodiments tin (Sn), zinc (Zn), and/or aluminum (Al) are used because of their known abilities of forming stable amalgams with mercury. Amalgamation with other metals could also facilitate the nucleation of mercury because the presence of another metal surface with a high affinity to mercury would lower the activation energy for forming a nucleus of critical radius.

In another embodiment of this invention a sulfur polymer cement (SPC) is embedded within the reactive CSMG which creates an in-situ stabilization reaction of mercury with sulfur polymer. According to published studies, the reaction between elemental mercury and sulfur can be completed at a moderate temperature (40°˜70° C.) with the formation of red cinnabar (HgS). The fact that elemental Hg is formed in-situ by a reduction reaction and stabilized by the surface ligands will facilitate a reaction with a sulfur polymer. By combining SPC with reactive CSMG, the present invention provides a composite system that performs adsorption, reductive reaction and immobilization of mercury all in one operation.

### EXAMPLES

The integration of three functions- adsorption, reaction and catalysis—into one nanopore composite has demonstrated tremendous incremental value to the CSMG technology for silver recovery. Table 3 represents the results from treating silver solutions of 1,000 ppm initial concentration.

TABLE 3

| | | | Silica- | CSMG- |
|---|---|---|---|---|
| | Silica-OH* | CSMG-SH** | OH—Fe*** | SH—Fe*** |
| Capacity (in | 30 | 70 | 100 | 600 |
| bed volume) | | | | |
| Efficiency | ~1000 ppb | <5 ppb | ~200 ppb | 2~5 ppb |
| (effluent | | | | |
| conc.) | | | | |

*Plain silica with —OH on the pore surface
**CSMG with thiol groups on the pore surface
***Iron particles are embedded as reactant

Both products with CSMG-SH have much higher treatment efficiencies (˜ppb level) than their non-ligand counterparts. The encapsulation of iron particles with CSMG-SH achieved the most significant increase in treatment capacity. At the same treatment efficiency, the treatment cost is proportionally reduced by an increase in capacity.

### Examples of Making CSMG-SH—Fe Composite

### CSMG-Fe Composite Made Using Orthosilicate (TEOS)

The CSMG may be made by typical sol-gel reactions represented by the following equations:

Hydrolysis: (C₂H₅O)₃Si—R+H₂O→(HO)₃Si—R+3C₂H₅OH

Coupling reaction: —Si—OH+(HO)₃Si—R→—Si—O—Si(OH)₂—R+H₂O.

As is the case with the synthesis of any organic-inorganic nanocomposite, the phase compatibility at the sub-micron level is an especially important factor to the quality of the composite. Particle size distribution at a nanometer scale can be monitored by Dynamic Light Scattering (Brookhaven Instruments BI-90+). A composite of 30% silica, 40% iron, and 30% of surface loaded thiol ligands can be prepared according to the following procedures.

Silica sol is prepared from TEOS, H₂O, ethanol and HCl, in the total molar ratio 1:2:4:0.0007. The mixture of 50 ml of silica sol and an amount (depending on the desired % of ligand loading) of 3-mercaptopropyltrimethoxysilane is added into a reaction vessel equipped with agitator, heating mantel, thermometer and nitrogen purge system. Additional amounts of water or ethanol are used to adjust the water/ethanol ratio in the solvent mixture so that their properties are suitable for the amount of ligand desired. After the reaction mixture is heated at 50 to 60° C. for 1 to 2 hours, a desired amount of Fe powder is added with vigorous stirring. Then, a NH₄OH solution is added to the mixture to induce gelation. After cooling, the Fe powder-loaded CSMG is aged over night and successively washed thoroughly with ethanol and water.

### CSMG-Clay-Fe Composite Made Using Silicic Acid

A silicic acid sol is prepared by ion-exchange using 4:1 (water:sodium silicates volume ratio). The solids content of the solution was 8.1 wt. %

The silicic solution (150 g) is heated to 48° C. and (3-mercaptopropyl) trimethoxysilane (15 g) and ethanol (15 g) are added and the solution is stirred with a magnetic bar. The methoxy groups hydrolyze and the solution turns clear after 10 min. After 30 minutes, the clay slurry is added to solution (43.5 g, ˜4.4 g of clay) and a high speed strirrer is used to disperse the clay. After a total reaction time of 65 minutes, the solution is cooled to 22 to 25° C. with an ice-water bath and a solution of sodium silicate (2.5:1 water:PQ “N”) is added dropwise while carefully monitoring the pH and under vigorous stirring. The pH increases from 2.3 to 7 at which point iron powder (200 mesh, 15.9 g) is added to the solution and a high speed strirrer is used to disperse the powder. Gelation occurrs after four minutes of mixing (at pH 7.5). After 10 minutes, the stirrer blade becomes difficult to remove, indicative of gel strength. The gel is aged at ambient temperature for one hour. The gel is broken into chunks and transferred to a 20 ml syringe with a 1.8 mm diameter opening. The gel is compressed and water (from synerisis) is expelled first and then the CSMG/iron rods are extruded onto an aluminum foil. The rods are dried by heating to 70° C. (in a vented space because of the methanol by-product). Heat drying minimizes the rusting of the iron.

The result of treating a standard solution with 1000 ppm initial silver concentration is shown in FIG. 4.

### Examples for Mercury Treatment

### Efficiency and Capacity of CSMG-SH—Fe Towards Mercury

### Preparation of High Porosity CSMG-Fe Composite

### Sample A.

Silicic acid is prepared by passing a solution of sodium silicate (9 wt % solids, PQ Corporation, N type product) through a column packed with a strongly acidic cation exchange resin (Rohm and Haas, Amberlite IR-120). To 200 g of the silicic acid solution, 16 g of (3-mercaptopropyl)trimethoxy silane and 30 g of ethanol are added and the mixture is heated to 50° C. while being agitated with a magnetic stirrer. The initially cloudy mixture becomes an almost clear solution after 10 minutes and after 30 minutes, an oil in water emulsion is formed by addition of 10 g of mineral (paraffin) oil and 0.4 g of a surfactant blend (80% Tween 80, 20% Span 80, ICI Americas). After an additional 15 minutes of stirring, the mixture is cooled to 25-30° C. and the pH of the mixture is increased to a value of 7-7.5 by addition of 2 M ammonium hydroxide solution. A mechanical high shear stirrer is used to disperse iron powder (200 US mesh) into the mixture which gels after 3 minutes. The gelled mixture is aged for 1 hour and then the gel is extruded into rods that are dried using forced hot air (120° C.). The mineral oil is extracted using hexane solvent. The resultant rods (Sample A, 1 mm diameter) have a density of approximately 1 g/cc and contain 62 wt % of iron. The thiol loading is 1.4 mmol/g.

### Sample B.

A comparative sample (Sample B) is prepared using the procedure outlined for Sample A but without addition of the iron powder. The thiol loading is 3.7 mmol/g.

The effectiveness for removal of mercury ions using these engineered materials is determined using a simple batch experiment. A starting solution (pH 2.3) containing 1000 ppm of mercury (as Hg²⁺) in the presence of nitrate counter ions is prepared and contacted separately with Sample A and Sample B. The concentration of mercury ions remaining in the solutions after an arbitrary time period of 24 hours is determined using cold-vapor atomic absorption spectroscopy in conjunction with reduction of the mercuric ions with a sodium borohydride solution. Table 7 summarizes the results of the batch test. The CSMG-iron composite removes approximately 0.46 g of mercury per g of solid material while comparative Sample B (which has a higher effective loading of the expensive thiol functional group) removes 0.39 g of mercury per g of solid. Sample A has better performance at a lower material cost compared to Sample B.

TABLE 7

| | Sample A | Sample B |
|---|---|---|
| | CSMG-iron | CSMG |
| Wt. % Iron in Sample | 62% | 0% |
| Effective thiol loading mmol/g | 1.4 | 3.7 |
| solution: solids L/mg | 772 | 654 |
| 24 hr Hg²⁺ concentration (mg/L) | 305 | 490 |
| Hg removed as g/g CSMG rods | 0.46 | 0.39 |
| Hg removed as mmol/g | 2.27 | 1.96 |

### Material Optimization

Depending on the results of the efficiency and capacity measurements of the base composites, several variations of the adsorbent material may be prepared to optimize the performance of the reactive adsorbent. Modifications typically include changing the ligand loading density, reactant type, and ligand type. The goal of these modifications is to find the material composition that can achieve the highest efficiency and capacity. However, in strong contrast to photographic silver recovery, the efficiency requirement for mercury recovery is much more stringent because of the environmental risks associated with the metal. Thus, the correlation between treatment efficiency and loading density of thiol ligand groups may be first determined.

(2.a) Adsorption and Catalysis: Adjusting Surface Ligand Density

The high loading of surface thiol groups achieved by CSMG improves the reduction of mercury ions by iron particles. There are at least three mechanisms to increase the reaction rate in flow-filtration mode:
The surface adsorbed mercury ions serve as a reactant reservoir and significantly increase the diffusion of mercury ions to a reaction site.
The retention of mercury ions by selective adsorption prolongs average reaction time.
The surface monolayer of thiol groups can stabilize metal nanoparticles and may serve as a nucleation site for mercury metal.

The third mechanism, involves lowering the activation energy of the critical nuclei in a homogeneous nucleation, and is a catalytic function of the ligand groups. With this catalytic effect, the formation of a critical metal nucleus is easier and faster. Without wishing to be bound by any theory it is believed that this is part of the reason that the CSMG-SH—Fe may achieve a capacity six times greater than that of CSMG-Fe. The critical metal nucleus, an activation complex for homogeneous nucleation, could be the activated state for other mercury reactions as well. Thus, the ligand groups may also perform functions that help catalyze the amalgamation of mercury with another metal or reaction with a sulfur polymer.

Utilizing any or all of these three mechanisms facilitates an in-situ reaction for achieving successful reactive treatment of mercury. The concentration of mercury in groundwater would be much lower than the silver concentration in photographic waste. Moreover, forming a critical nucleus in homogeneous nucleation of metal is very difficult because of its exceptionally high surface tension. Without a dense layer of surface thiol groups, the reactive adsorption of mercury may not be effective.

It is applicants' current understanding that the higher the ligand loading, the better the efficiency and capacity. However, the ligand group, Si—(CH₂)₃—SH, does contain a hydrophobic part which might not be favorable to a hydrophilic reaction. By using a composite with three different degrees (30%, 60%, 100%) of ligand loading the effects of ligand groups on the reaction may be demonstrated while all other factors (iron loading, pH, and initial mercury concentration) are kept constant.

(2.b) Reduction Reaction

The reaction of iron particles with a silver ion is a simple oxidation-reduction (redox) reaction:

Fe+2 Ag⁺→Fe⁺²+2 Ag.

Based on standard reduction potentials at 25° C. and thermodynamic principles, the reduction reaction of mercury should proceed.

Ag⁺+e−→Ag εₒ=0.799 volt

Hg₂²⁺+2e−→2 Hg εₒ=0.788 volt

2 Hg²⁺+2e−→Hg₂²⁺εₒ=0.920 volt.

If the reaction does not proceed or goes too slowly, the reasons are kinetics. As described above, the surface thiol groups should lower the activation energy and substantially improve the reaction. However, if the reaction is still not rapid enough, embodiments of the invention will use reactive metals to replace the iron particles.

Metal particles or flakes of tin, zinc and aluminum are embedded respectively with CSMG following the same procedure described above for iron inclusion. These metals all are capable of forming an amalgam with metallic mercury. Amalgam formation with liquid mercury might provide a stabilization effect similar to the effect provided by ligand groups. In that case, the metal surface itself could become the site of nucleation, and the amalgam formation would reduce the need for a high-curvature, high-tension mercury surface.

(2.c) Other Functional Groups

Although it may not interact with mercury as strongly as —SH, one embodiment of the invention incorporates —NH₂ functional groups in the CSMG. The —NH₂ ligand group is known to stabilize many transitional metal ions through strong coordination bonding. A ligand with chelating —NH₂ groups could be as effective as EDTA. One unique feature of an amino group is its ability to form complex ions, both cationic and anionic, with a transition metal via coordination bonding. Therefore, the amino ligand group may offer a variety of coordination bonding opportunities under different solution environments. The characteristic of its surface charge can be adjusted by a change of pH. Gamma-amino modified silica may be made using silicic acid and amino-propyltrimethoxysiliane (APTES) as the surface modifier. An adequate amount of ethanol is added to the silicic acid, and the mixture is stirred until homogenous. At this point in the synthesis process, APTES is added with stirring, and the solution viscosity begins to increase rapidly as the gel forms. The gel is aged at room temperature for about 24 hours and then washed with deionized water so the ethanol can be removed.

In still other embodiments of the invention, the functional ligand is a solid redox reagent that is capable of reacting with an adsorbed species. As an aspect of this embodiment electrodes may be embedded within the nanopore reactive adsorbent to drive the redox reaction(s) by electrolytic processes. The electrodes may be connected to external electrical leads using techniques known to those skilled in the art of nanotechnology.

In another embodiment of the invention a biochemical reaction can be used to react with the waste species, which may be a biological contaminant, for example. The biochemical reaction may include recovery and/or removal of a microorganism, such as, for example, bacteria, fungus, spores, viral particles, whole cells or cell fragments. As the functional ligand in this embodiment of the invention a protein, such as an enzyme, or an antibody, which may be a polyclonal or monoclonal antibody, may be used as the reactive ligand for reacting with the waste species.

Still other potential applications include, for example, those described in the aforementioned application Ser. No. 10/110,270.

### 3. Amalgamation and Immobilization

In an embodiment of the invention the efficiency and capacity of reactive CSMG for mercury treatment is increased to the point where it is 5-10 times higher than CSMG while the efficiency improves to the same level achievable (˜ppb) by CSMG. The capacity increase may be achieved by mercury metal formation through in-situ reduction. In a field operation, the mercury recovered within a filter needs to be transported and completely immobilized before the waste can be safely disposed.

Because mercury metal is liquid, it must be solidified before it can be safely transported. In this embodiment of the invention, another metal is mixed with the reactive adsorbent to capture the liquid mercury through amalgam formation. Currently, mercury amalgam is still being used for some types of dental work. The vapor pressure of mercury amalgam is much lower than pure mercury. However, amalgamated mercury, even with a lower level of activity, is still chemically reactive. Consequently, it would not meet the 0.025 mg/L leaching required by Resource Conservation and Recovery Act and cannot be disposed without further treatment.

For mercury, the only currently acceptable form of disposal is the formation of a stable compound with a sulfide. Among all stable mercury compounds, mercury sulfide has the lowest solubility product (Kₛₚ=3×10⁻⁵³). If mercury is completely reacted with sulfur, the leaching rate will be much lower than any current standard. The present invention utilizes a sulfur polymer with the reactive CSMG adsorbent to provide the in-situ immobilization of mercury.

(3.a) Aluminum Flakes

The initial test of amalgamation is conducted by mixing aluminum flakes with the reactive adsorbents in a test column. For a typical test, 10 grams of reactive CSMG and 10 grams of aluminum flakes are mixed together and used to fill a column with a capacity of 15 ml. A solution of mercury (II) nitrate with a mercury concentration of 100 ppm at a flow rate of 0.5 ml/minute is used. The concentrations of the mercury (II) nitrate solution passed through the column are assayed. After the test, aluminum flakes are separated from the adsorbent pellets and analyzed for mercury content. Other metals such as tin and zinc may also be evaluated for potential use. If the reduction reaction by iron particles is not effective (i.e. low mercury production), these metals may be embedded within the CSMG to make a new reactive adsorbent based on the procedures described above.

(3.b) Sulfur Polymer Cement

In embodiments of this invention an in-situ reaction is induced between mercury and embedded sulfur polymer within the reactive adsorbent. The reaction sequence is as follows:

Fe+Hg²⁺→Fe²⁺+Hg,

Hg+(—S—)ₙ→HgS.

Integrating these two reactions should create several significant benefits. The catalytic effect of surface thiol groups mentioned above for nucleation is expected to promote a reaction with polymer sulfide as well. At present, to obtain an appreciable reaction of elemental mercury with sulfur polymer, the mixture must be heated to a temperature of greater than 40° C. Because the product, HgS, is one of the most stable compounds, the heating is for providing activation energies. According to Arrhenius equation for rate constant,

$$k = A exp ( - \frac{{E}_{a}}{RT} ) ,$$

lowering activation energy, Eₐ, has the same effect as raising temperature. Consequently, with a high loading of thiol groups, the reaction between freshly produced mercury and sulfur polymer may proceed at an appreciable rate without a need for heating¹ because heating would be expected to provoke the release of mercury vapor during processing. ¹ This is an oversimplified conjecture of the reaction kinetics. There are other factors such as diffusion rate, viscosity that may play important roles in the reaction. Observation of the reaction kinetics may be employed to find the best processing conditions for a complete reaction of mercury with the sulfur polymer.

The leaching tests reported by Fuhrmann et al. (Waste Management 22 (2002) 327-333; see also, U.S. Pat. No. 6,399,849) indicated that immobilization by a sulfur polymer with the additive sodium sulfide nonahydrate was consistently the best in terms of performance. In embodiments of the present invention the presence of thiol ligands would provide a similar impact on immobilization. The effectiveness of immobilization can be determined by a series of leaching tests according to the Toxicity Characteristic Leaching Procedure. Results would be favorably compared with those in Fuhrmann et al. CSMG with such an in-situ immobilization may, therefore, be used to achieve the removal, recovery and immobilization of mercury in one operation using one reactive composite material.

### Characterization of Results from Treating Silver with CSMG-SH—Fe

A JOEL JSM-5900LV Scanning Electron Microscope (SEM) with ultimate resolution of 3 nm was used to obtain images of the CSMG-Iron composite samples before and after exposure to a silver nitrate solution. Samples were coated with carbon, mounted in epoxy, then ground and polished to 1-micron diamond finish, followed by polishing with colloidal silica. An energy dispersive spectrometer (EDS) microanalysis attachment was used to obtain quantitative elemental analyses from different regions of the CSMG-Iron composite. Resolution for EDS measurements is about one micron although actual analysis volume is dependent of the atomic mass of the material in the electron beam.

### Results of Elemental Analysis (EDS)

TABLE 4
(From FIG. 2, Region 1)

| | App | Intensity | | Weight % | |
|---|---|---|---|---|---|
| Element | Conc. | Corrn. | Weight % | Sigma | Atomic % |
| O | 3.80 | 0.3923 | 27.59 | 1.33 | 71.32 |
| Fe | 0.83 | 0.9188 | 2.56 | 0.37 | 1.90 |
| Ag | 22.93 | 0.9338 | 69.85 | 1.31 | 26.78 |
| Totals | | | 100.00 | | |

The dendritic structures formed on the surface of the CSMG-Iron composite are comprised substantially of pure silver.

TABLE 5
(From FIG. 2, Region 2)

| | App | Intensity | | Weight % | |
|---|---|---|---|---|---|
| Element | Conc. | Corrn. | Weight % | Sigma | Atomic % |
| O | 7.93 | 0.5114 | 29.80 | 0.94 | 51.08 |
| Al | 0.77 | 0.8692 | 1.70 | 0.16 | 1.73 |
| Si | 15.96 | 0.9350 | 32.74 | 0.57 | 31.96 |
| S | 4.06 | 0.7959 | 9.78 | 0.31 | 8.37 |
| Fe | 0.50 | 0.8567 | 1.11 | 0.21 | 0.55 |
| Ag | 9.64 | 0.7440 | 24.86 | 0.66 | 6.32 |
| Totals | | | 100.00 | | |

The absorbed silver in Region 2 is on a nanometer scale as would be expected for silver absorbed upon the surface of the nanoporous silica microstructure.

TABLE 6
(From FIG. 2, Region 3)

| | App | Intensity | | Weight % | |
|---|---|---|---|---|---|
| Element | Conc. | Corrn. | Weight % | Sigma | Atomic % |
| Si | 0.29 | 0.6191 | 0.60 | 0.13 | 1.18 |
| Mn | 0.44 | 0.9761 | 0.57 | 0.17 | 0.58 |
| Fe | 78.61 | 0.9990 | 98.83 | 0.21 | 98.24 |
| Totals | | | 100.00 | | |

The feature of region 3 is comprised wholly of the iron particle.

1. A nanopore reactive adsorbent composite material, having a composition and microstructure, which integrate adsorption, reaction and catalysis.

2. A nanopore reactive adsorbent, according to claim 1, whose integration of adsorption, reaction and catalysis is achieved by modifying nanopore surfaces with dense ligand groups.

3. A nanopore reactive adsorbent according to claim 2 wherein the nanopore surfaces have a density of 1 to 5 ligand groups per nm².

4. A nanopore reactive adsorbent, according to claim 1, whose porous adsorbent comprises a Chemically Surface Modified Gel.

5. A nanopore reactive adsorbent, according to claim 1, which comprises more than one embedded solid reactant phase effective to accomplish a sequence of reactions of which at least one reaction is catalyzed by the surface ligand groups.

6. A nanopore reactive adsorbent according to claim 1, comprising reactive metal particles effective as in-situ reducing agent.

7. A nanopore reactive adsorbent according to claim 6, wherein the reactive metal particles are Mg, Sn, Al, Fe, or Zn or mixture thereof.

8. A nanopore reactive adsorbent according to claim 1, comprising from about 20 to 30 wt % nanoporous silica, from about 40 to 75 wt % embedded solid reactant phase and from about 10 to 30 wt % surface-loaded ligand groups.

9. A nanopore reactive adsorbent according to claim 1, comprising from about 20 to 25 wt % nanoporous silica, from about 50 to 65 wt % embedded solid reactant phase and from about 10 to 20 wt % surface-loaded ligand groups.

10. A macroporous adsorbent comprising the nanopore reactive adsorbent of claim 1.

11. A macroporous adsorbent according to claim 10, in the form of porous rods.

12. A macroporous adsorbent according to claim 11, wherein the rods are about 1 millimeter diameter.

13. A macroporous adsorbent according to claim 10, wherein the porous rods have a density of about 1 g/cc.

14. A macroporous adsorbent according to claim 10, in the form of pellets or granules.

15. A nanopore reactive adsorbent comprising reactive particles comprised of a solid redox reagent capable of reacting with adsorbed species.

16. A nanopore reactive adsorbent comprising reactive particles comprised of a protein effective to react with an adsorbed biological species.

17. A nanopore reactive adsorbent according to claim 16, wherein the organism is at last one of bacteria, enzyme, fungus, cell, or antibody and wherein the protein is an enzyme or an antibody.

18. A nanopore reactive adsorbent according to claim 1, the composition of which will effect redox reaction(s) driven by electrolytic processes occurring at electrodes that are embedded within the nanopore composite when connected to external electrical leads.

19. A nanopore reactive adsorbent according to claim 18, further comprising external electrical leads connected to said electrodes.

20. A method for producing the nanopore reactive adsorbent according to claim 1 comprising:
(a) selecting a ligand group that can stabilize the activated complex of a desired reaction,
(b) reacting a silica precursor with a coupling reagent of the selected ligand in an aqueous alcoholic medium under an inert atmosphere and at an elevated temperature within the range of from about 40° C. to about 80° C. to cause the coupling reactant to condense and react with said silanol groups to form a grafted silica sol;
(c) mixing and stirring the grafted silica sol with particles for the reactive phases in the nanopore reactive adsorbent; and
(d) gelling the product of (c).

21. A nanopore reactive adsorbent according to claim 5, where a second reactive phase is a sulfur polymer or another metal effective to immobilize liquid mercury in-situ.

22. A nanopore reactive adsorbent according to claim 18, where the adsorbent is produced with sol-gel precursors other than silica.

23. A method according to claim 20, where the modified sol is made from metal oxide precursors other than silica.

24. A method for removing mercury from a liquid contaminated with mercury comprising contacting the liquid with a nanopore reactive adsorbent as set forth in claim 7 to adsorb and convert the mercury to adsorbed mercury.

25. A method according to claim 24, further comprising contacting the adsorbed mercury with polymeric sulfur to thereby immobilize the adsorbed mercury.

26. A method according to claim 24, wherein the polymer sulfur is embedded in the nanopore reactive adsorbent.

27. A method according to claim 24, further comprising removing the immobilized mercury from said liquid.

28. A method according to claim 24, wherein the reactive metal particles comprise iron.

29. A method according to claim 28, further comprising separating the mercury loaded reactive adsorbent by applying a magnetic field to the liquid.
